(19) United States
(12) Patent Application Publication
(10) Pub. No.: US 2004/0098483 A1
(43) Pub. Date: May 20, 2004

(54) Triggering communication from devices that self-initiate communication

(76) Inventor: Glenn R. Engel, Snohomish, WA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/298,106

(22) Filed: Nov. 14, 2002

(51) Int. Cl. G06F 15/16

(52) U.S. Cl. 709/227

(57) ABSTRACT

Techniques for triggering communication from devices that self-initiate communication. A system according to the present techniques includes a first device that self-initiates communication to a second device via a communication network and a mechanism for enabling the second device to provide a trigger signal to the first device that causes the first device to initiate communication to the second device via the communication network in response to the trigger signal.

### BACKGROUND OF THE INVENTION

1. Field of Invention

The present invention pertains to the field of device communication. More particularly, this invention relates to triggering communication from devices that self-initiate communication.

2. Art Background

A wide variety of devices may be employed in a network communication environment. For example, measurement devices may be placed in locations where measurements are desired and a communication network may be used to report obtained measurements to an information recording facility. Similarly, actuator/control devices may be placed in desired locations and a communication network may be used to carry control information to/from the devices.

The devices on a communication network may implement a protocol for communication in which some devices are configured to self-initiate communication to other devices. One example is a client-server arrangement in which client devices initiate communication with a server. For example, a client device may self-initiate communication with a web server by sending an http command to the web server. The web server may send updated information to the device in the response to the http command.

It may be desirable under some circumstances to send information to a device without waiting for the device to self-initiate communication. For example, it may be desire-able for a server to provide new configuration information to a client device without waiting for the client device to initiate communication with the server.

A variety of factors may hinder attempts to send information to devices that self-initiate communication. For example, a web client device may be located behind a firewall that prevents an outside web server from initiating communication with the device. In another example, a device may have a network connection such as an Internet dial-up connection that prevents direct accesses when the device is not connected. Unfortunately, such limits on device communication may limit the ability to control devices in a timely fashion and may impact the overall performance of a network-based application.

### SUMMARY OF THE INVENTION

Techniques are disclosed for triggering communication from devices that self-initiate communication. A system according to the present techniques includes a first device that self-initiates communication to a second device via a communication network and a mechanism for enabling the second device to provide a trigger signal to the first device that causes the first device to initiate communication to the second device via the communication network in response to the trigger signal. The present techniques in some embodiments enable the employment of existing services to trigger communication without the need for building separate infrastructures for triggering communication.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 shows a system that employs the present techniques for triggering communication;

FIG. 2 shows another embodiment of a system that employs the present techniques for triggering communication;

FIG. 3 shows yet another embodiment of a system that employs the present techniques for triggering communication;

FIGS. 4-8 show various embodiments of a device according to the present techniques.

### DETAILED DESCRIPTION

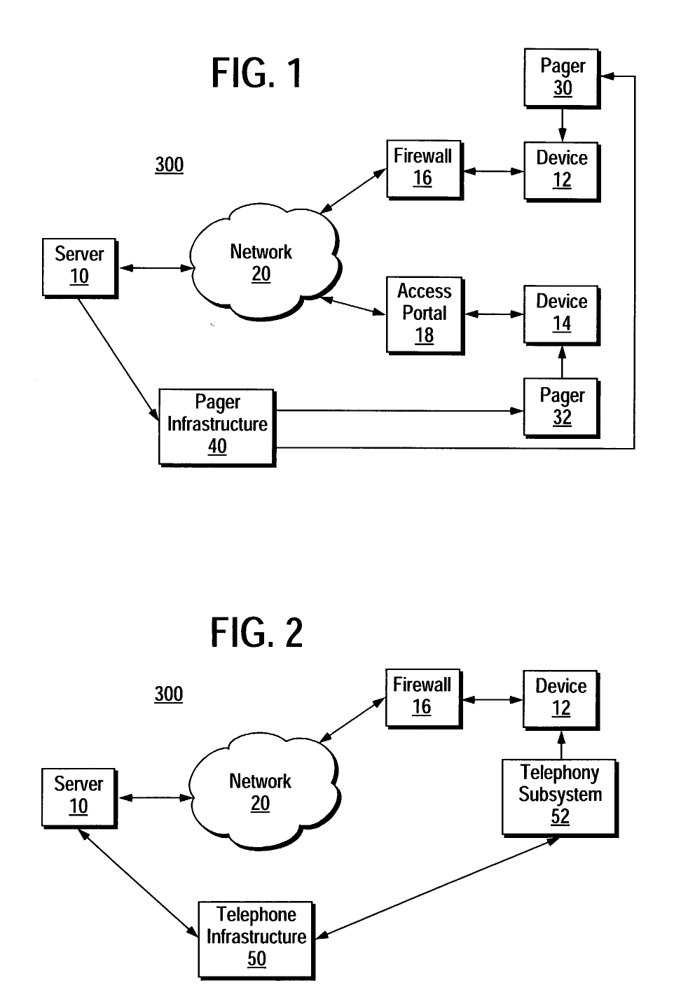

FIG. 1 shows a system 300 that employs the present techniques for triggering communication. The system 300 includes a server 10 a pair of devices 12-14 that communicate via a network 20. The server 10 and the devices 12-14 implement a protocol in which each device 12-14 self-initiates communication to the server 10.

In one embodiment, each device 12-14 self-initiates communication by generating an http command and transferring the http command to the server 10. One example of an http command for self-initiating communication is an http get command. A response to an http get command by the server 10 may include information returned to the requesting device in the form of a web page.

The devices 12-14 may be configured to periodically self-initiate communication to the server 10. A communication transaction in which a device self-initiates communication to the server 10 according to a specified period may be referred to as a device check in. For example, the devices 12-14 may periodically transfer http get commands to the server 10 to periodically check in and obtain updated configuration information.

The topology of connections between the devices 12-14 and the network 20 are such that communication transactions that originate on the network 20 may be hindered from reaching the devices 12-14. For example, the device 12 is located behind a firewall 16 that prevent commands and/or messages that are sent by the server 10 from reaching the device 12. In addition, the device 14 connects to the network 20 via an access portal 18 that may under some conditions prevent accesses to the device 14 from the network 20. For example, the access portal 18 may be a dial-up Internet connection that may prevent the server 10 from reaching the device 14 when the dial up connection to the device 14 is not active.

The topology of connections between the devices 12-14 and the network 20 may hinder efforts by the server 10 to initiate communications to the devices 12-14. This may interfere with application-specific functions associated with the server 10 and the devices 12-14.

For example, the server 10 having updated configuration information for the device 12 may have to wait for the next check in by the device 12 and then provide the updated configuration information to the device 12 through the firewall 16 using a response to an http get command from the device 12. Similarly, the server 10 having updated configuration information for the device 14 may have to wait for the next check in by the device 14 when a dial up connection to the device 14 is active.

The server 10 overcomes these obstacles by sending trigger signals to the devices 12-14 when communication is needed—for example when new configuration information is available for the devices 12-14. The trigger signals cause the devices 12-14 to initiate communication to the server 10 and obtain the updated information as if it were a normal device check in.

The server 10 triggers the devices 12-14 to initiate communication to the server 10 in the embodiment shown in FIG. 1 by sending a trigger signal to the devices 12-14 using a paging mechanism. The devices 12-14 are associated with a pair of pagers 30-32, respectively, which is capable of receiving page messages via a pager infrastructure 40.

The server 10 triggers communication from the device 12 by sending a page to the pager 30 via the pager infrastructure 40. The page may be sent to initiate communication with the device 12 regardless of when the next check in by the device 12 is scheduled to occur. In response to the page from the server 10, the device 12 performs a check in to the server 10 via the network 20—for example by sending an http get command to the server 10. In response to the http get command, the server 10 may provide the device 12 with updated configuration information.

Similarly, the server 10 triggers communication from the device 14 by sending a page to the pager 32 via the pager infrastructure 40. In response to the page from the server 10, the device 14 performs a check in to the server 10 via the network 20 and the server 10 may provide updated configuration information to the device 14 at that time.

The updated configuration information provided to the devices 12-14 in response to an http get command may be any type of information. The type of information may depend on the function of the devices 12-14. For example, if the devices 12-14 are measurement devices then the updated configuration information may include new measurement parameters and/or communication parameters—for example a new check in period, etc.

Each device 12-14 includes a communication subsystem that enables communication via the network 300 including, for example, the elements suitable for http communication and periodic self-initiated communication and for responding to trigger signals from the server 10 according to the present teachings. The communication subsystems in the devices 12-14 may be implemented as a combination of hardware processing/communication resources and code.

The pager infrastructure 40 may be any type of pager network. The pagers 30-32 may be integrated into the corresponding devices 12-14 or may be separate and attached via suitable connections to the devices 12-14. Either way the pagers 30-32 provide the processing/communications resources in the devices 12-14 with trigger signals derived from received page messages so that communication to the server 10 may be initiated.

Alternatively, the devices 12-14 may each include a wireless telephony subsystem that is capable of receiving page messages via the pager infrastructure 40. The server 10 may send a page via a wireless telephony subsystem to either device 12-14 to trigger it to initiate communication back to the server 10.

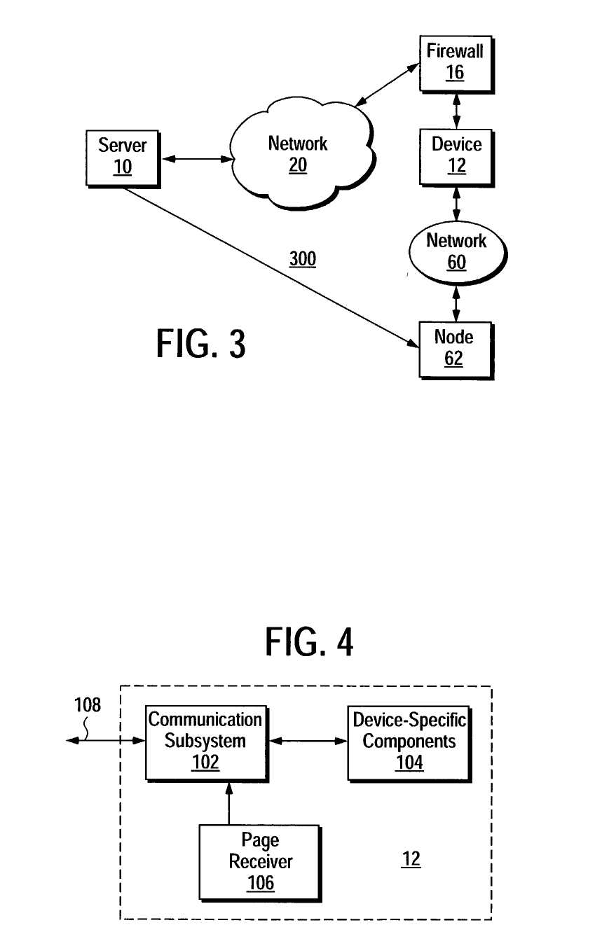

FIG. 2 shows another embodiment of the system 300 that employs the present techniques for triggering communication. In this embodiment, the device 12 includes a telephony subsystem 52 that is capable of receiving calls placed via a telephone infrastructure 50.

The server 10 in this embodiment provides a trigger signal to the device 12 to cause it to initiate communication to the server 10 by calling the telephony subsystem 52 via the telephone infrastructure 50. When the telephony subsystem 52 detects a ring it sends a trigger signal to the device 12. The device 12 then initiates communication to the server 10 via the network 20 in response to the trigger signal from the telephony subsystem 52—for example by sending an http get command to the server 10.

The server 10 may send touch-tones during a call to the telephony subsystem 52 that provide additional information which may be passed on to the device 12. The telephony subsystem 52 decodes the touch-tones and passes the decoded data onto the device 12.

The telephone infrastructure 50 may be a public telephone infrastructure, a wireless system, a PBX, etc. The telephony subsystem 52 is adapted to the telephone infrastructure 50 and may be integrated into the device 12 or may be separate and attached via suitable connections to the device 12. The telephony subsystem 52 provides the processing/communications resources in the device 12 with a trigger signal when a ring is detected so that communication to the server 10 may be initiated.

Alternatively, the server 10 may trigger the device 12 to initiate communication to the server 10 by sending an email message to the telephony subsystem 52 via the telephone infrastructure 50. The telephony subsystem 52 provides the email message to the device 12 and the contents of the email message may instruct the device 12 to initiate communication to the server 10 via the network 20. The email message may be sent via wireless communication and/or landline depending on the implementation of the telephone infrastructure 50.

For the embodiment shown in FIG. 1, if the pager infrastructure 40 supports email transmission then the server 10 may trigger the device 12 to check in to the server 10 by sending an email message to the pager 30 via the pager infrastructure 40.

In another alternative, the server 10 may trigger the device 12 to check in to the server 10 by sending an email message to the device 12 via the network 20 through the firewall 16. An email message passes through the firewall 16 in contrast to an http message that may be blocked.

In another alternative, the server 10 provides a trigger signal to the device 12 to cause it to check in to the server 10 by initiating a data call to the device 12. A data call may be established via the pager infrastructure 40 or the telephone infrastructure 50 when IP connectivity is supported. The device 12 in response to a data call may initiate communication to the server 10 via the network 20—for example by sending an http get command to the server 10.

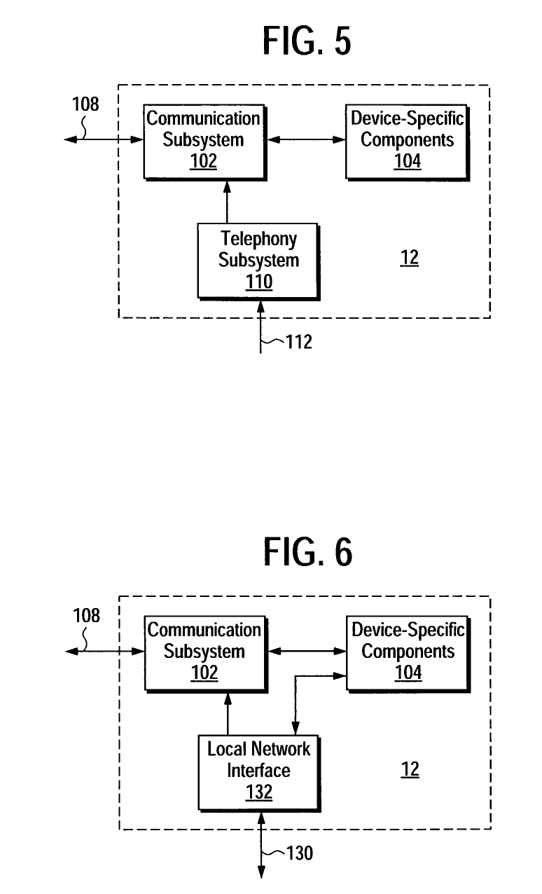

FIG. 3 shows another embodiment of the system 300 that employs the present techniques for triggering communication. In this embodiment, the device 12 is capable of communication via a network 60 as well as the network 20. The network 60 may be, for example, a local area computer network, a proprietary network, a specialized device network, etc.

A node 62 is shown which is capable of communication on the network 60 and which is capable of receiving messages from the server 10. The node 62 may be a computer system or a specialized device. The node 62 may receive messages from the server 10 using a direct connection to the network 20, i.e. without an intervening firewall or access provider or may receive messages via a telephone and/or pager network, dial up connection, etc.

Alternatively, the node 62 may periodically check in to the server 10 and may receive a trigger message in response to its normal device check in.

The server 10 in this embodiment provides a trigger signal that causes the device 12 to initiate communication to the server 10 by sending a trigger message to the node 62. For example, the server 10 may send a trigger message to the node 62 using a data call, a dial up modem connection, a page, an email message, an http command, an IP command, etc., depending on the available communication channel between the server 10 and the node 62.

The node 62 forwards the received trigger message on to the device 12 via the network 60 using a format that is appropriate to the network 60. The trigger message when received by the device 12 causes it to initiate communication to the server 10 via the network 20—for example by sending an http get command to the server 10.

The present techniques may yield reduced latency when the server 10 sends configuration changes to the devices 12-14. In addition, these techniques may provide the server 10 with enhanced control over when configuration changes are received by the devices 1214 in comparison to a system in which a server must wait for device check in to perform configuration changes.

The present techniques enable the employment of existing services, for example, telephone, email, paging, existing networks, etc., to trigger communication without the need for building separate infrastructures for that purpose. These techniques may be used to conserve bandwidth on the network 20 by using trigger signals sent via an alternate path to direct the devices 12-14 to communication to the server 10 only when necessary.

In addition, the present techniques for triggering communication may be used to provide other information to the devices 12-14. One example is to use a page, phone call, email message, etc. to communicate to the devices 12-14 that an alternate server is to be used—for example when logging measurements—depending on the application.

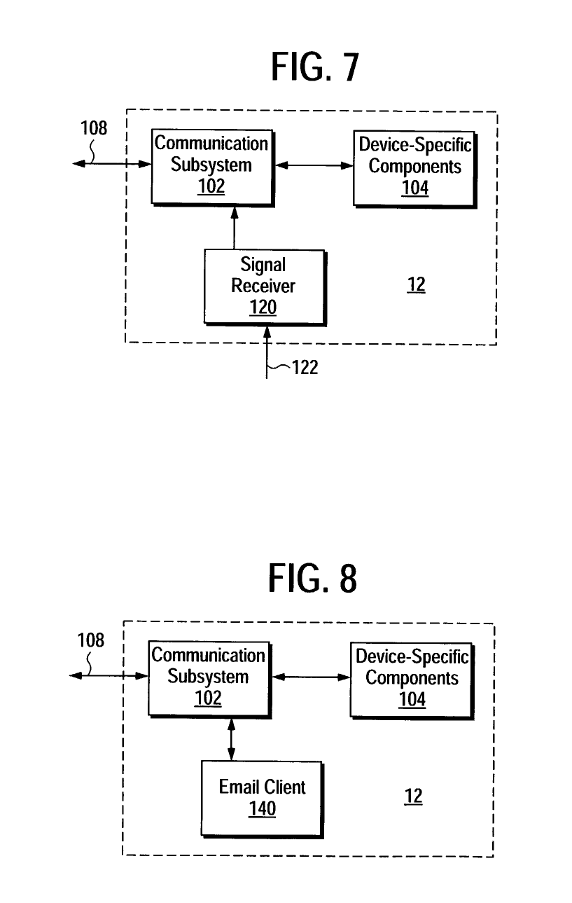

FIG. 4 shows one embodiment of the device 12 according to the present techniques. The device 12 includes a communication subsystem 102 and a set of device-specific components 104. A triggering subsystem of the device 12 in this embodiment is a page receiver 106.

The device-specific components 104 may be embodied as a combination of hardware/code for performing a device-specific function. For example, if the device 12 is a measurement device then the device-specific components 104 may include hardware and code for obtaining measurements according to a specified set of configuration information which may be set by the server 10.

The communication subsystem 102 includes communication hardware and code for self-initiating communication to the server 10 via a communication link 108. For example, the communication subsystem 102 may implement the appropriate protocol layers for functioning as a web client and initiating http communication to the server 10.

The page receiver 106 is capable of receiving paging messages that provide a trigger signal to the device 12. The page receiver 106 is adapted to the particular implementation of the pager infrastructure 40. In response to a received page message, the page receiver 106 provides a signal to the communication subsystem 102 which causes it to initiate communication to the server 10 without waiting for the next scheduled check in.

FIG. 5 shows another embodiment of the device 12 according to the present techniques. A triggering subsystem in this embodiment of the device 12 is a telephony subsystem 110 that receives a telephone call via a signal path 112. The signal path 112 may be a telephone line or a signal path to a receiving antenna for a wireless implementation. In response to a received telephone call, the telephony subsystem 110 provides a signal to the communication subsystem 102 that causes it to initiate communication to the server 10 without waiting for the next scheduled check in. Alternatively, the telephony subsystem 110 may be capable of receiving a page message and then triggering the communication subsystem 102 in response to the page message.

FIG. 6 shows yet another embodiment of the device 12 according to the present techniques. A triggering subsystem in this embodiment of the device 12 is a local network interface 132 that enables reception of a trigger message via the network 60. The local network interface 132 may be embodied as a combination of hardware/code that is adapted to a particular implementation of the network 60. The local network interface 132 provides a signal to the communication subsystem 102 that causes it to initiate communication to the server 10 in response to a trigger message received via a communication link 130 of the network 60.

FIG. 7 shows another embodiment of the device 12 according to the present techniques. A triggering subsystem of the device 12 in this embodiment is a signal receiver 120 for receiving a trigger signal 122. The telephony subsystem 110 provides a signal to the communication subsystem 102 that causes it to initiate communication to the server 10 in response to the trigger signal 122.

The trigger signal 122 may be generated by an external pager and indicate that a page was received from the server 10. The trigger signal 122 may be generated by an external telephony subsystem that detects the ring of an incoming telephone call or data call or receipt of an email message, etc. The trigger signal 122 may be generated by an external interface to a local network in response to receipt of a trigger message, an email message, etc. The trigger signal 122 may be generated by an external system, for example a computer system or other device, that detects receipt of a trigger message.

FIG. 8 shows yet another embodiment of the device 12 according to the present techniques. A triggering subsystem in this embodiment of the device 12 is an email client 140 that has the capability of receiving email messages through the communication subsystem 102 that originate with the server 10 and that pass through any intervening firewalls. The email client 140 analyzes received email messages and if a received email message includes a trigger message it provides a signal to the communication subsystem 102. The communication subsystem 102 initiates communication to the server 10 in response to the signal without waiting for the next device check in to occur.

The foregoing detailed description of the present invention is provided for the purposes of illustration and is not intended to be exhaustive or to limit the invention to the precise embodiment disclosed. Accordingly, the scope of the present invention is defined by the appended claims.

What is claimed is:

1. A system, comprising:
first device that self-initiates communication to a second device via a communication network;
means for enabling the second device to provide a signal to the first device that causes the first device to initiate communication to the second device via the communication network in response to the signal.

2. The system of claim 1, wherein the means for enabling comprises means for sending a page message to the first device.

3. The system of claim 1, wherein the means for enabling comprises means for placing a phone call to the first device.

4. The system of claim 1, wherein the means for enabling comprises means for sending an email message to the first device.

5. The system of claim 1, wherein the means for enabling comprises means for providing the signal to a node on a local network which forwards the signal to the second device via the local network.

6. A method for triggering communication, comprising the steps of:
providing a first device with a mechanism for self-initiating communication to a second device via a communication network;
providing a signal to the first device that causes the first device to initiate communication to the second device via the communication network in response to the signal.

7. The method of claim 6, wherein the step of providing a signal comprises the step of sending a page message to the first device.

8. The method of claim 6, wherein the step of providing a signal comprises the step of placing a phone call to the first device.

9. The method of claim 6, wherein the step of providing a signal comprises the step of sending an email message to the first device.

10. The method of claim 6, wherein the step of providing a signal comprises the step of providing the signal to a node on a local network which forwards the signal to the second device via the local network.

11. A device, comprising:
communication subsystem which is capable of self-initiating communication to a second device via a communication network;
triggering subsystem which is capable of obtaining a signal from the second device and of causing the communication subsystem to initiate communication to the second device via the communication network in response to the signal.

12. The device of claim 11, wherein the triggering subsystem comprises a page receiver.

13. The device of claim 11, wherein the triggering subsystem comprises a telephony subsystem.

14. The device of claim 11, wherein the triggering subsystem comprises a local network interface.

15. The device of claim 11, wherein the triggering subsystem comprises a signal receiver capable of receiving a trigger signal from an external system.

16. The device of claim 15, wherein the external system is a computer system.

17. The device of claim 15, wherein the external system is a pager.

18. The device of claim 15, wherein the external system is a telephony subsystem.

19. The device of claim 11, wherein the triggering subsystem comprises a an email client.
